(19) United States
(12) Patent Application Publication
(10) Pub. No.: US 2018/0264697 A1
(43) Pub. Date: Sep. 20, 2018

(54) METHOD FOR MOLDING A PART, FOR EXAMPLE FOR VEHICLE INTERIORS, TYPICALLY A DASHBOARD AND/OR INTERNAL PANELS, AND CORRESPONDING PART

(71) Applicant: UNITEAM ITALIA S.R.L., Quarto d'Altino (IT)

(72) Inventors: Carlo ISGRÒ, Quarto d'Altino (IT); Piertommaso CARRARO, Quarto d'Altino (IT)

(21) Appl. No.: 15/923,938

(22) Filed: Mar. 16, 2018

(30) Foreign Application Priority Data
Mar. 17, 2017 (IT) 102017000029818

(51) Int. Cl. B29C 45/16; B32B 7/02; B32B 27/08; B32B 27/32; B29C 45/14; B29C 45/26

(52) U.S. Cl. CPC B29C 45/1671; B29K 2023/12; B32B 27/08; B32B 27/32; B29C 45/1676; B29C 45/1642; B29C 45/1635; B29C 45/14065; B29C 45/1418; B29C 45/2681; B32B 2605/003; B29C 2045/14155; B29C 2045/14213; B29C 2045/2683; B29C 2045/2685; B29C 2045/2689; B32B 7/02

(57) ABSTRACT

An injection molding method of a part for vehicle interiors includes arranging a mold having a first injection chamber defining in negative a base of the part. Thermoplastic material is injected into the first chamber and the base is extracted from the first chamber and placed in a second injection chamber. A lining film is inserted in the second chamber and deforming it to arrange the film on an outer surface thereof, adhering to an esthetic wall of the second chamber opposite a functional wall. An intermediate plastic layer is injected in a gap between an inner wall of the base facing the lining film, and an inner surface of the lining film opposite the outer surface to create a single sandwich structure. The intermediate layer is between the lining film and the base, has lower hardness than the base and forms a yielding padding for the lining film.

This application claims benefit of Serial No. 102017000029818, filed 17 Mar. 2017 in Italy and which application is incorporated herein by reference. To the extent appropriate, a claim of priority is made to the above-disclosed application.

### FIELD OF APPLICATION

The present invention refers to a method for molding a part, for example for vehicle interiors, typically a dashboard and/or internal panel, and the corresponding molded part, for example for vehicle interiors, made by the molding method.

### PRIOR ART

It is well known that vehicle interiors include a plurality of panels which, for example, form part of the dashboard, interior door trim, instrument panel, and so on.

These parts are typically made of a frame or core of plastic material that is covered with leather, imitation leather, or a soft material that is resistant to scratching. It is also known that processes, such as photoengraving, can be performed on the plastic part in order to create a decorative pattern that creates a roughness effect similar to leather.

Solutions involving leather coverings are perceived as being of superior quality by the user, and are soft to the touch and comfortable: however, these solutions are definitely costly.

Solutions consisting of photoengraved or embossed thermoplastic material are definitely more economical than solutions involving leather or imitation leather coverings, but they often suffer from poor resistance to scratching, ultraviolet light, and fatty substances released by users' skin. In addition, these solutions are usually rigid to the touch, since the surface treatments are applied directly to plastic materials: this rigidity is perceived as low quality by users and therefore is not acceptable for vehicles in a certain price range.

It is also known that thin pressed films creating a leather effect on the surface can be used: such films can be colored and are made of materials that withstand abrasion, scratching, and wear, as well as the action of fats from skin with which they may come into contact while the vehicle is being used.

However, the problem remains that such thin films, although resistant, are applied to the underlying plastic base and, as such, the resulting effect is one of extreme rigidity which, as seen earlier, is perceived to be of poor quality.

In order to create greater softness, there are foaming solutions known as “press lamination,” but these are very costly and do not ensure good molding repeatability.

However, it is not possible to directly use films with a built-in sponge in the injection process, since the foam tends to be damaged upon contact with the injected plastic material.

### SUMMARY OF THE INVENTION

Consequently, there is a need to overcome the drawbacks and limitations cited in reference to the prior art.

In particular, there is a need to provide a molding method making it possible to obtain a part for vehicle interiors that is both economical to make, resistant to scratching and chemical agents, and soft to the touch.

### DESCRIPTION OF THE DRAWINGS

Further features and benefits of the present invention will be understood more clearly from the following description of its preferred and non-limiting embodiments, in which:

FIG. 1 shows a schematic perspective view of a molded part for vehicle interiors according to the present invention;

FIG. 2 shows a view of enlarged part II of FIG. 1;

FIG. 3 shows a cross-sectional view of the part in FIG. 1, along section plane III of FIG. 1;

FIG. 4 shows a view of enlarged part IV of FIG. 3;

FIGS. 5-13 show cross-sectional views of successive molding steps according to the present invention;

FIGS. 14-22 show schematic views of some details and/or variants of the molding steps in accordance with the present invention, which are described further below.

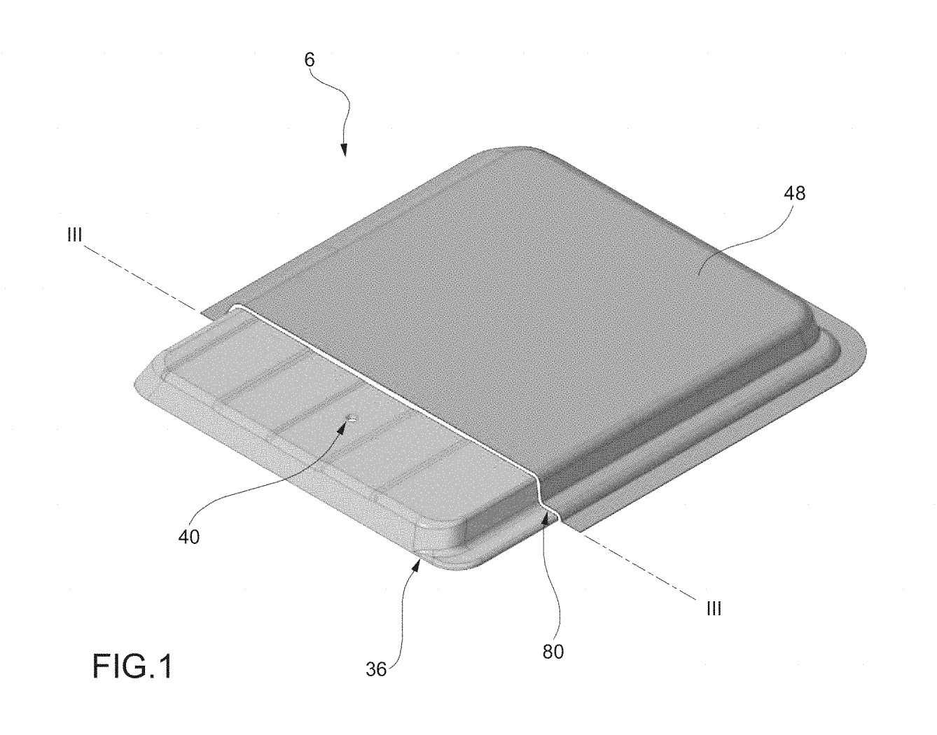

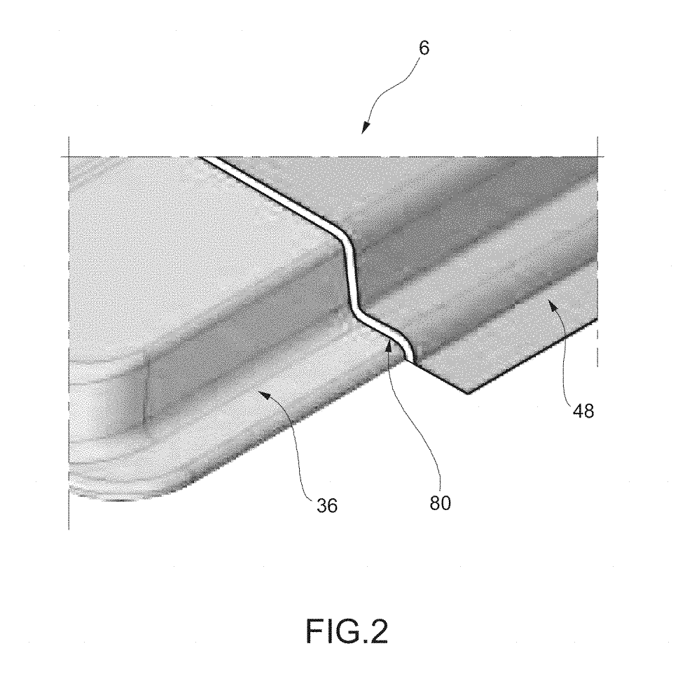

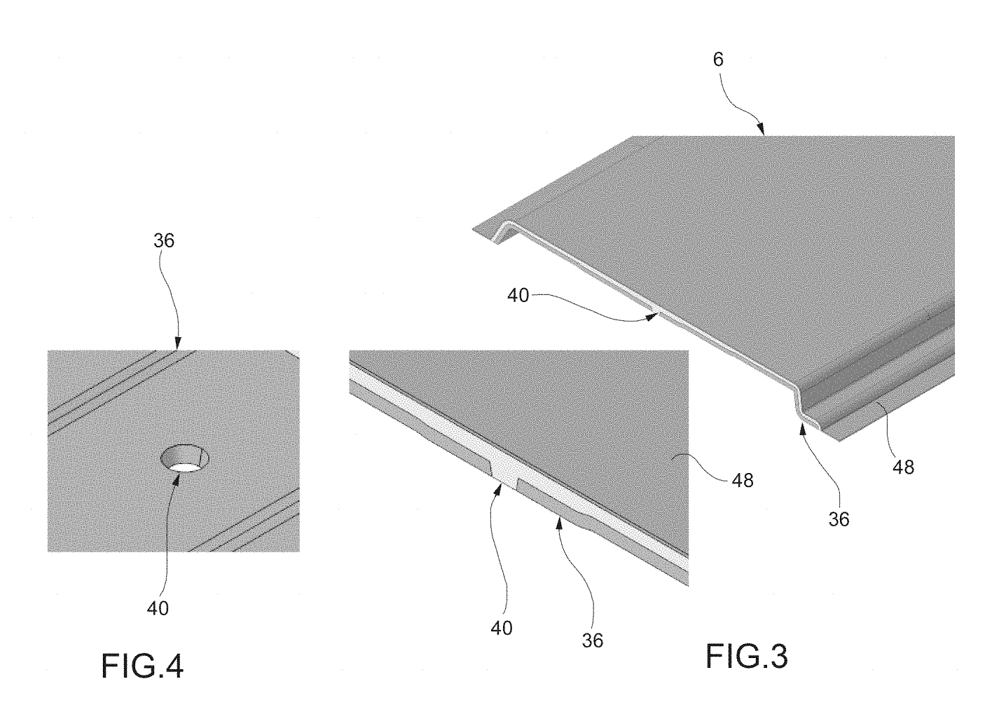

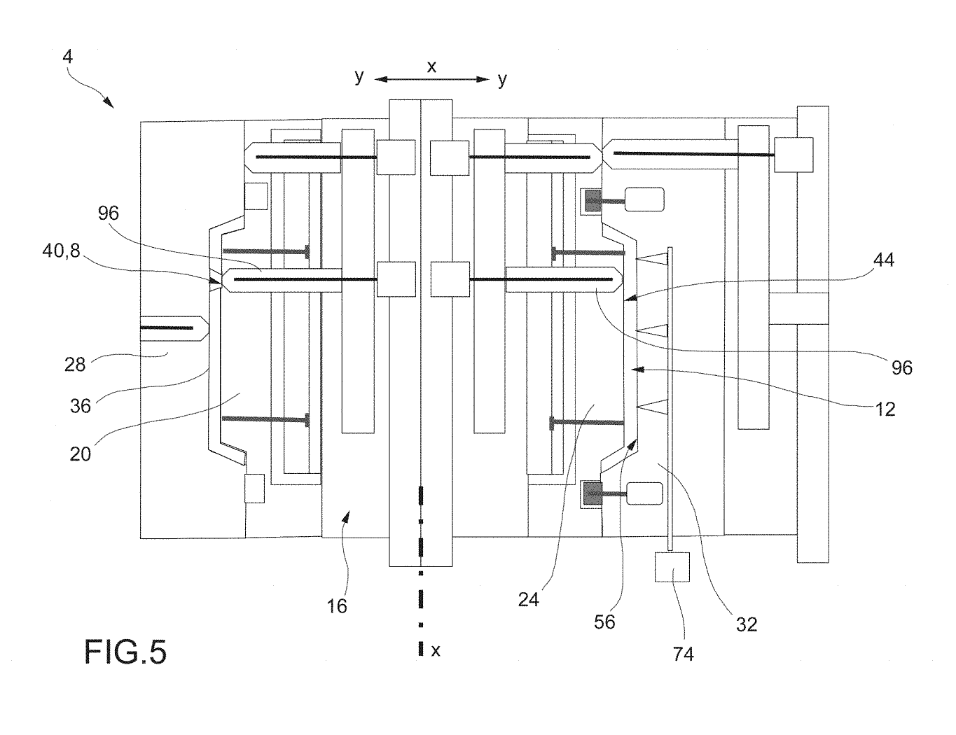

The elements or parts of elements that are in common between the embodiments described below are indicated with the same number references.

### DETAILED DESCRIPTION

In reference to the aforementioned Figures, the number 4 overall refers to a general schematic view of a mold for component 6 for vehicle interiors, in accordance with the present invention.

Mold 4 is preferably a cube mold comprising at least two injection chambers, i.e. a first injection chamber 8 and a second injection chamber 12.

Mold 4 comprises a central body 16 rotating about an axis of rotation X-X. Central body 16 supports a pair of punches, i.e. first and second punches 20, 24 diametrically opposed to each other, alternatively facing first and second injection chambers 8, 12, as further described below.

These punches typically are movable in a Y-Y direction of movement or a closing direction of mold 4 substantially perpendicular to the axis of rotation X-X.

Mold 4 also comprises first and second dies 28, 32 which pair, respectively, with first and second punches 20, 24 so as to define first and second injection chambers 8, 12.

The molding method for a part 6 for vehicle interiors in accordance with the present invention will now be described.

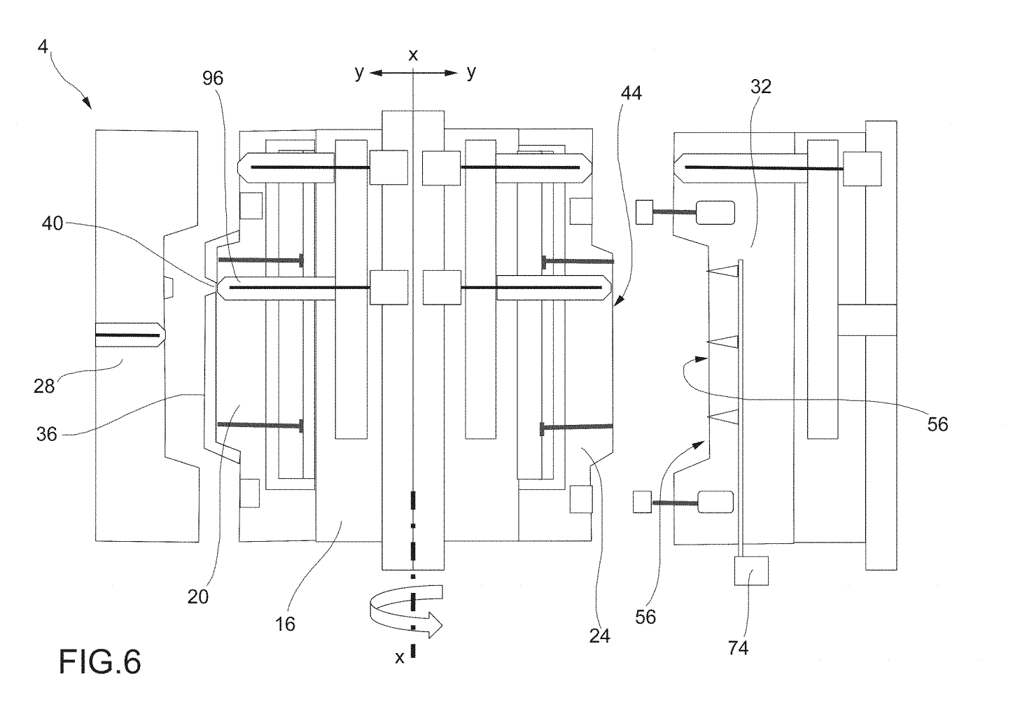

In particular, the method comprises the steps of:
making mold 4 so as to have first injection chamber 8 shaped to define a negative of base or core 36 of said part 4,
injecting thermoplastic material, such as polypropylene, into said first injection chamber 8 (FIG. 5).

Preferably, after injection of base 36, this item will have one or more through holes 40 that will be used in the subsequent injection steps.

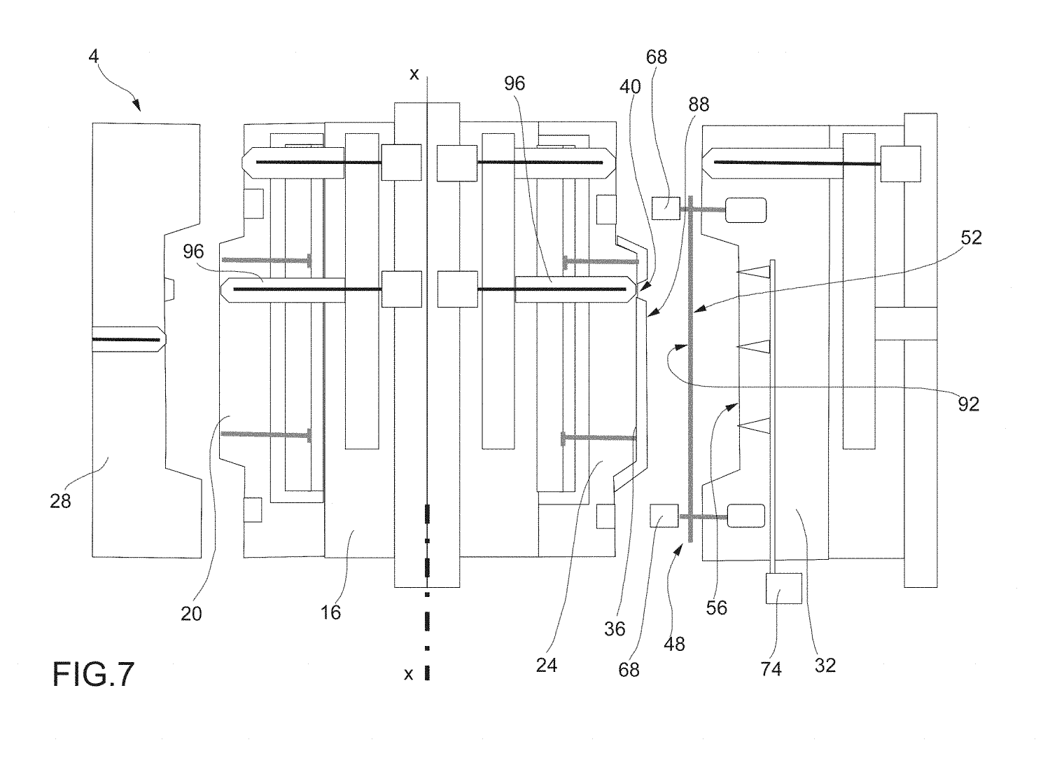

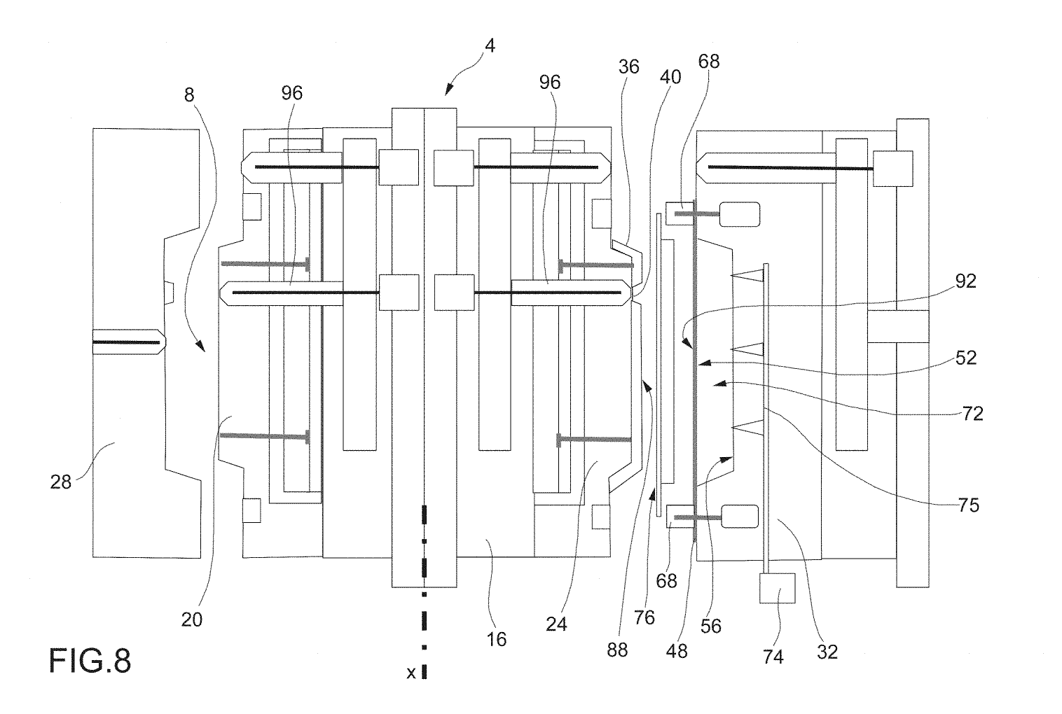

Mold 4 is then opened (FIG. 6), base 36, just molded, is transferred from first injection chamber 8 and is placed in second injection chamber 12 on the side of functional wall 44 of said second injection chamber 12 (FIG. 7).

Preferably, the transition of base 4 from first injection chamber 8 to second injection chamber 12 takes place by a 180° rotation of central body 16 of mold 4 about axis of rotation X-X (FIG. 7).

Next, a lining film 48 is placed in said second injection chamber 12 (FIG. 7).

Said lining film 48 must be deformed so as to be placed by its external side 52 so as to adhere to an esthetic side 56 of second injection chamber 12, opposite functional wall 44.

External side 52 of lining film 48 is the one intended to be visible from the outside of part 6, as it will cover base 36 of part 4.

It must be noted that the operation of having external side 52 of lining film 48 adhere to esthetic wall 56 of second injection chamber 12 is quite a delicate operation, since imperfect adhesion would cause the part to be discarded.

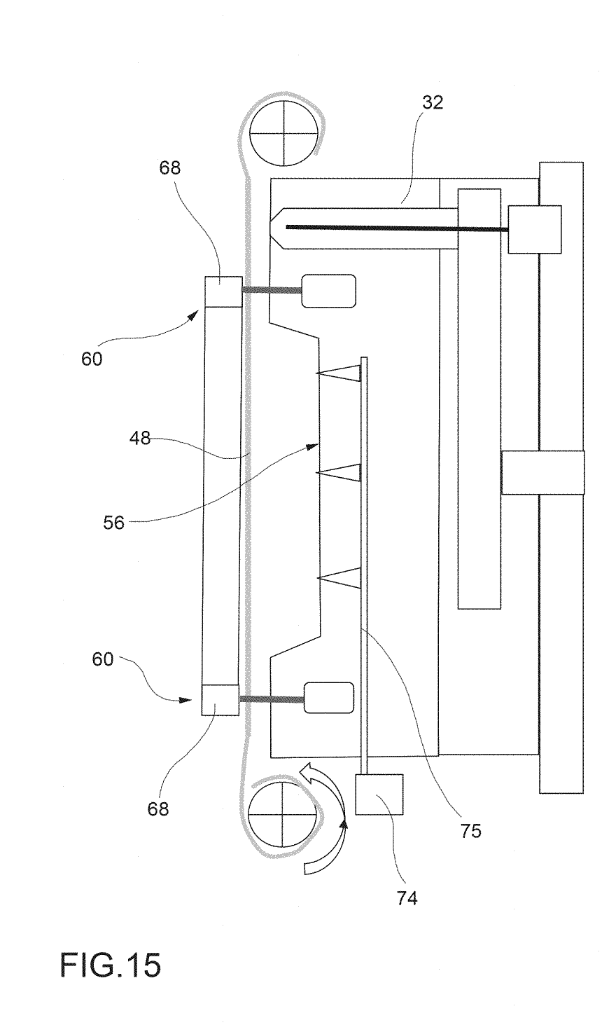

In particular, a step is provided, for example, to feed lining film 48 into second injection chamber 12 through an automatic feed device 60 (FIG. 14) comprising, for example, a pair of rollers that appropriately stretch and feed lining film 48 into second injection chamber 12.

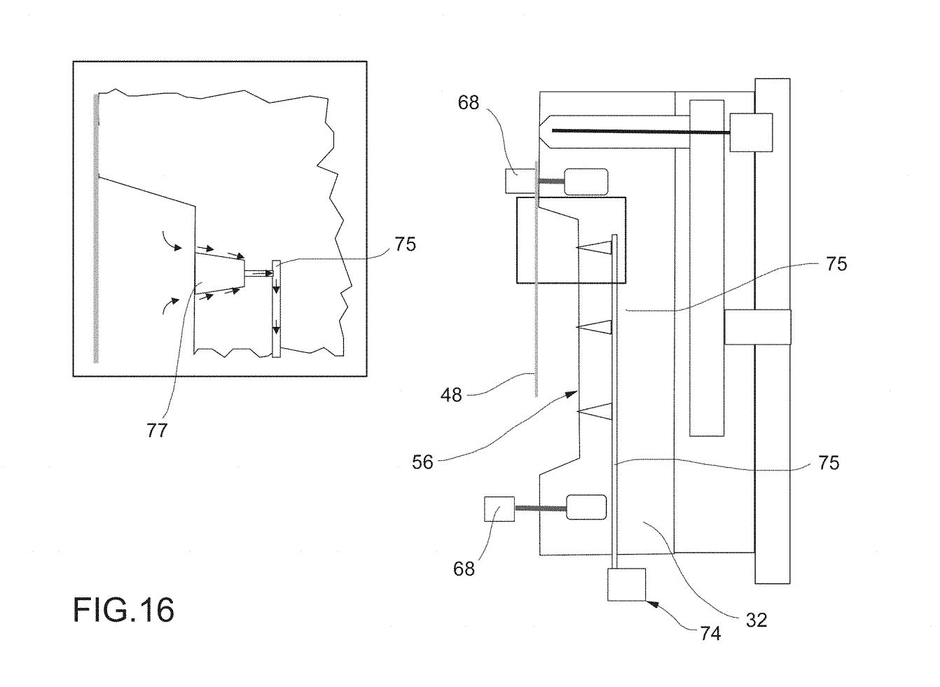

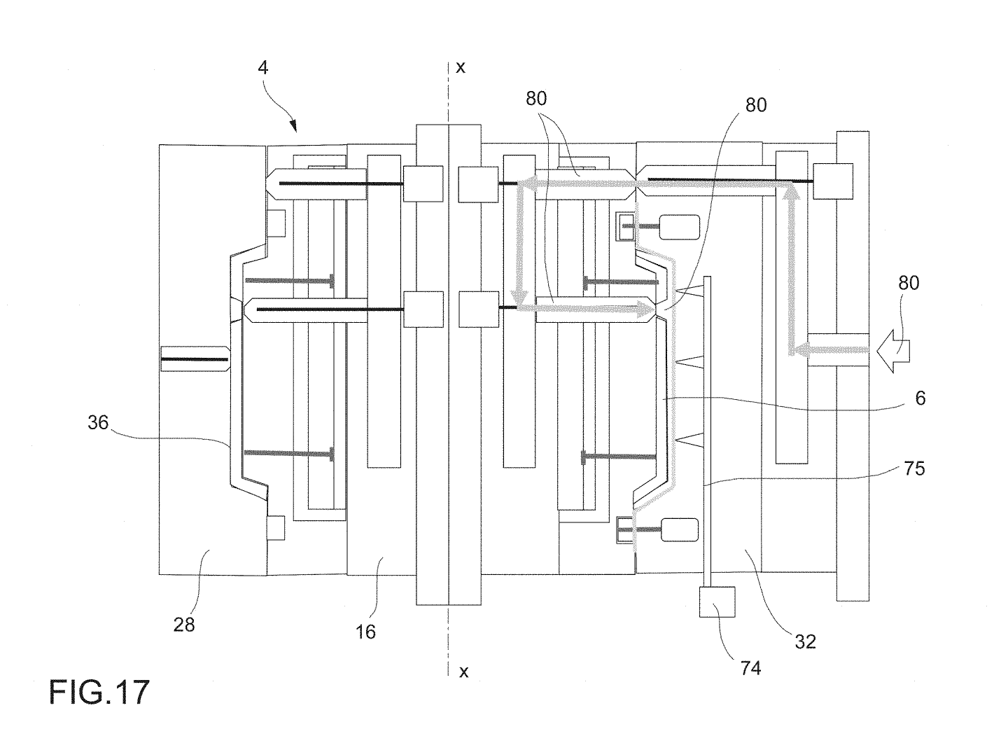

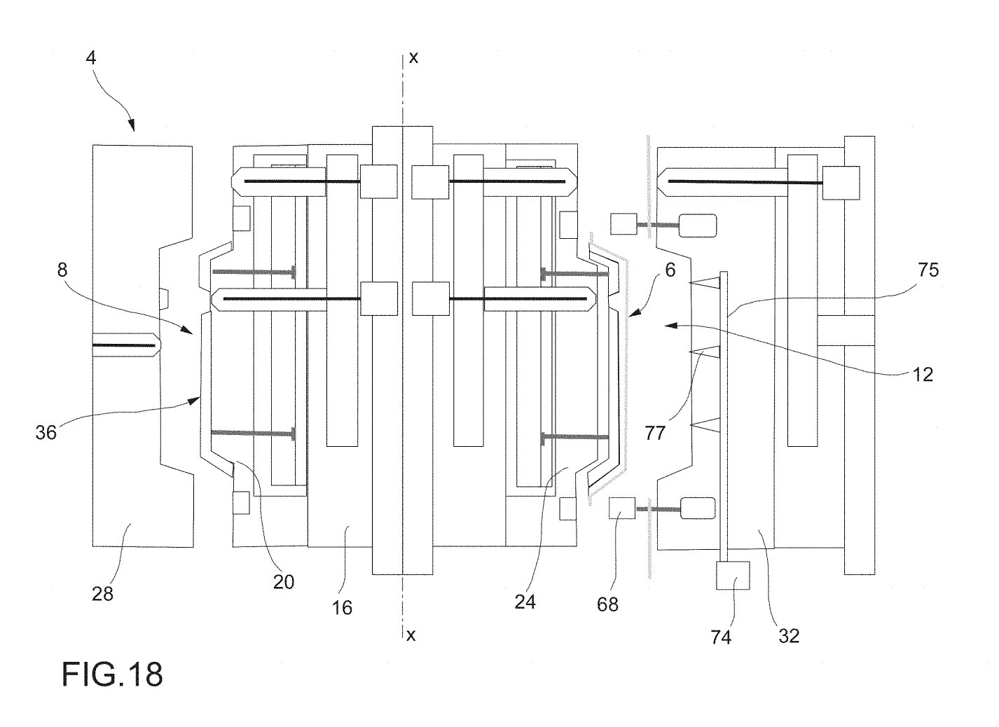

For example (FIGS. 15-16), a locking and sealing device 68 is furthermore provided, making it possible to hold and seal, on the side of esthetic wall 56, a portion of said lining film 48, equal to or greater than base 36, along the periphery thereof against mold 4, so as to exceed second injection chamber 12. In this way, a sealed chamber 72 is created between lining film 48 and esthetic wall 56 of second injection chamber 12.

Locking and sealing device 68 is substantially shaped like a closed frame that rests against esthetic wall 56 of second injection chamber 12, peripherally clamping and sealing lining film 48.

At this point, the film needs to be deformed, taking care not to stretch it with the punch: indeed, stretching could cause damage and breakage to the film.

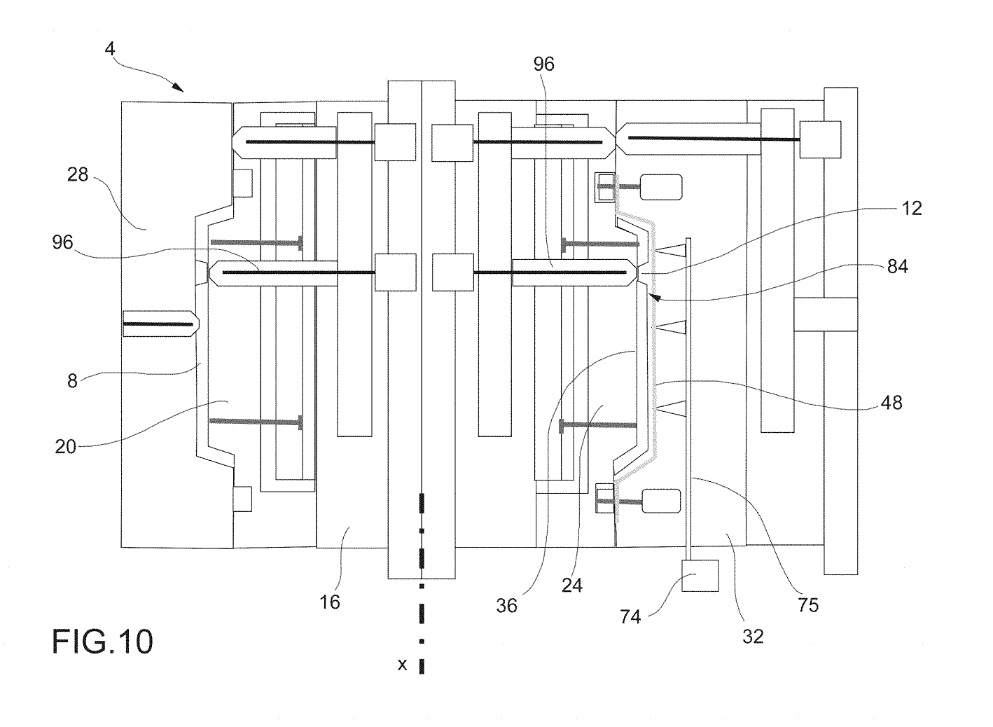

For this reason, according to one embodiment, there is a step for creating a vacuum in sealed chamber 72 so as to promote the deformation and the adhesion of lining film 48 to esthetic wall 56 of second injection chamber (FIG. 9). The vacuum can be created by connecting sealed chamber 72 to a vacuum pump 74.

Vacuum pump 74 can be connected, for example, to sealed chamber 72 by a series of lines 75 that lead to sealed chamber 72 through air passage plugs 77 with openings of sizes such that defects are not created in lining film 48.

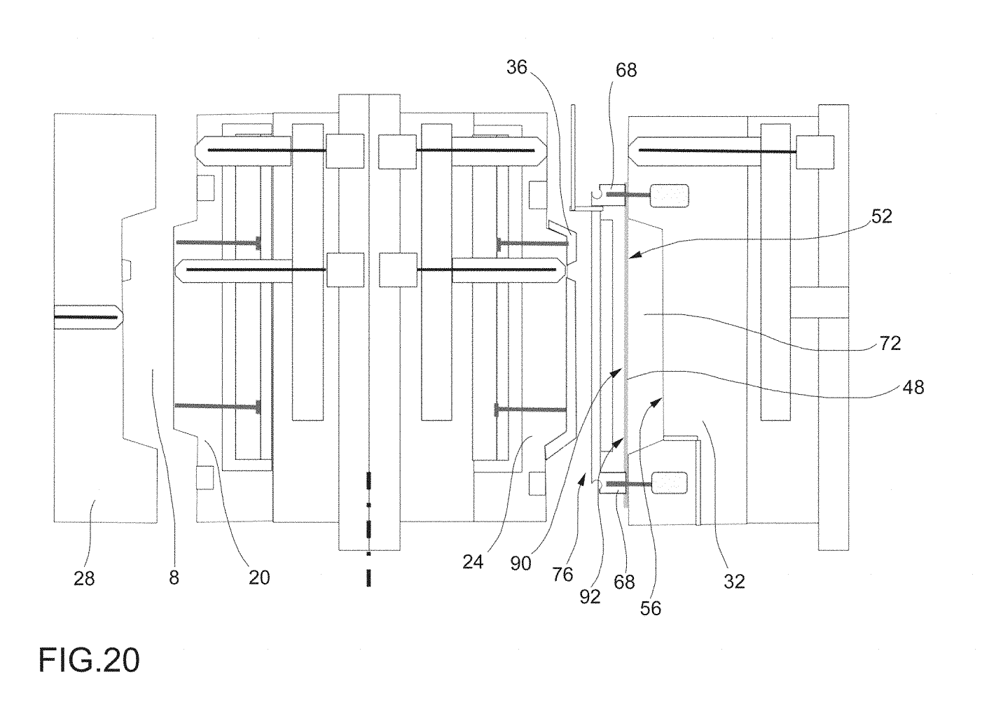

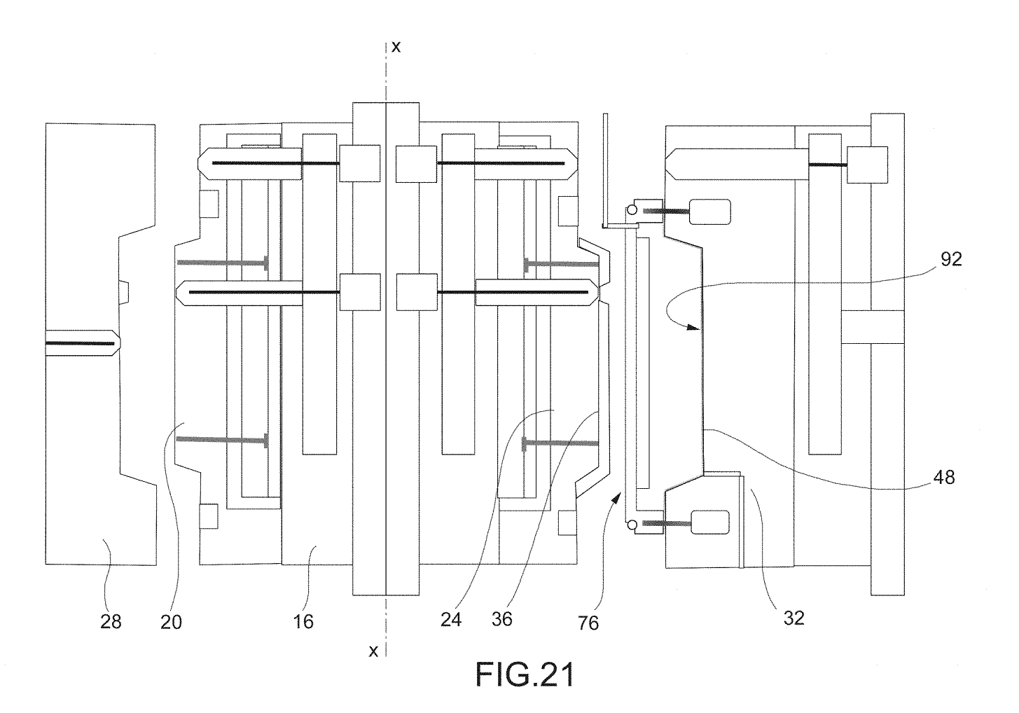

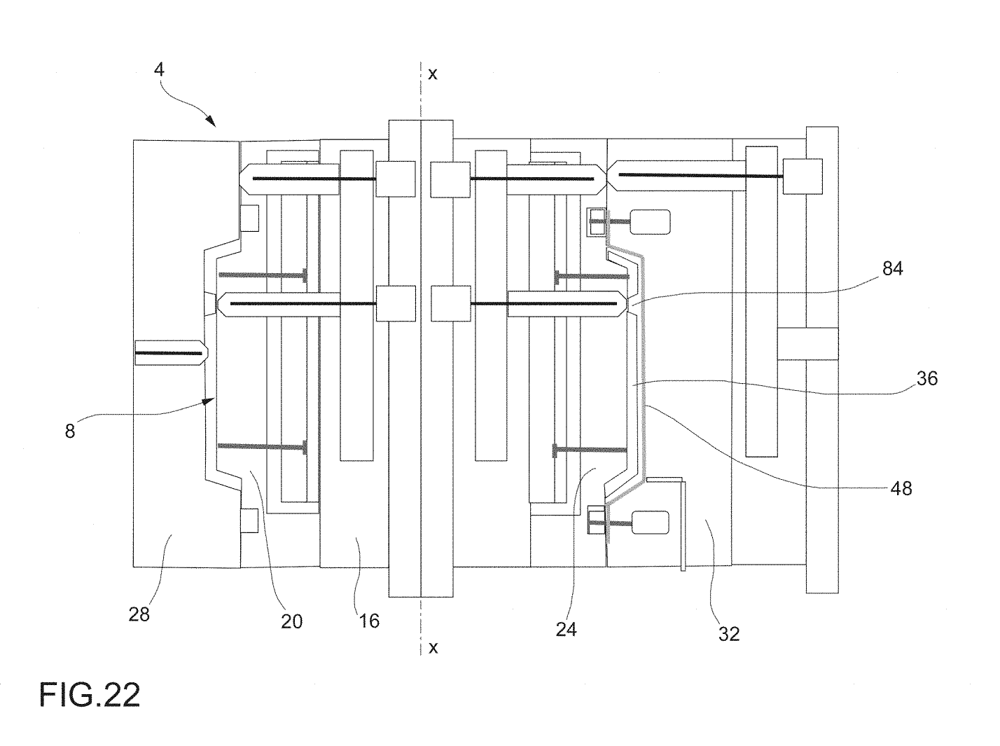

For example, the step for deforming lining film 48 can also be done by blowing compressed air into a second sealed chamber 90, once again to promote the deformation and adhesion of lining film 48 to esthetic wall 56 of second injection chamber 12 (FIGS. 20-22).

It is also possible to use a vacuum and compressed air in combination in order to achieve proper deformation of lining film 48.

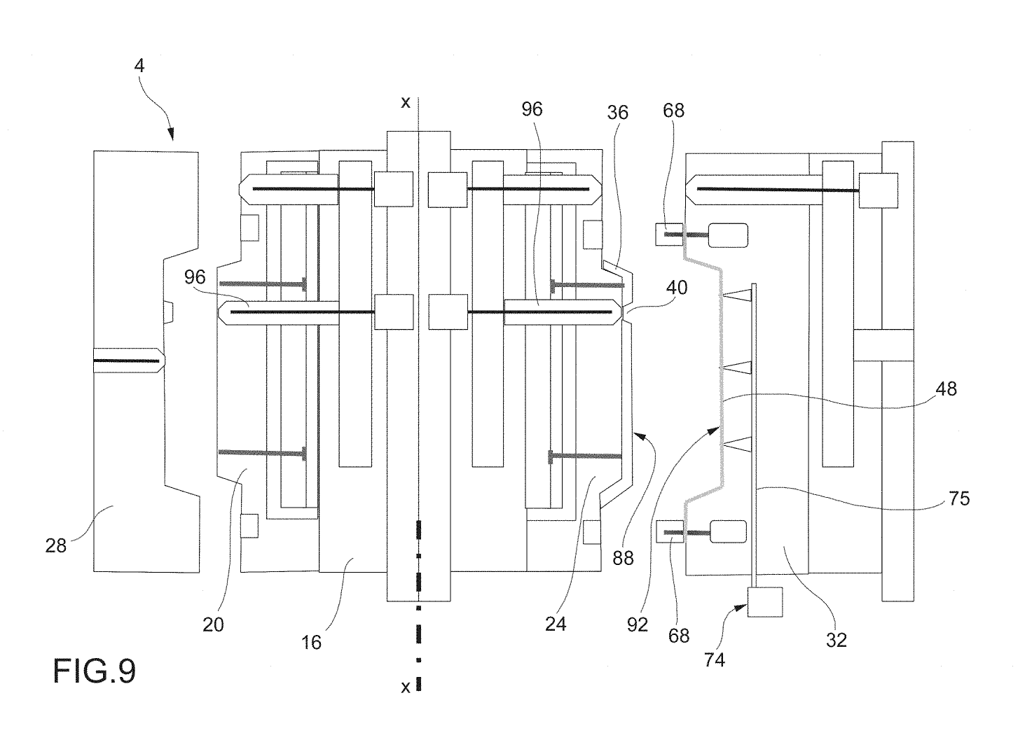

According to one embodiment, there is a step in which locking and sealing device 68 is provided with a heating device 76, such as an infrared heating device, in order to heat lining film 48 during the step for the deformation and adhesion of the film to esthetic wall 56 of second injection chamber 12 (FIG. 8).

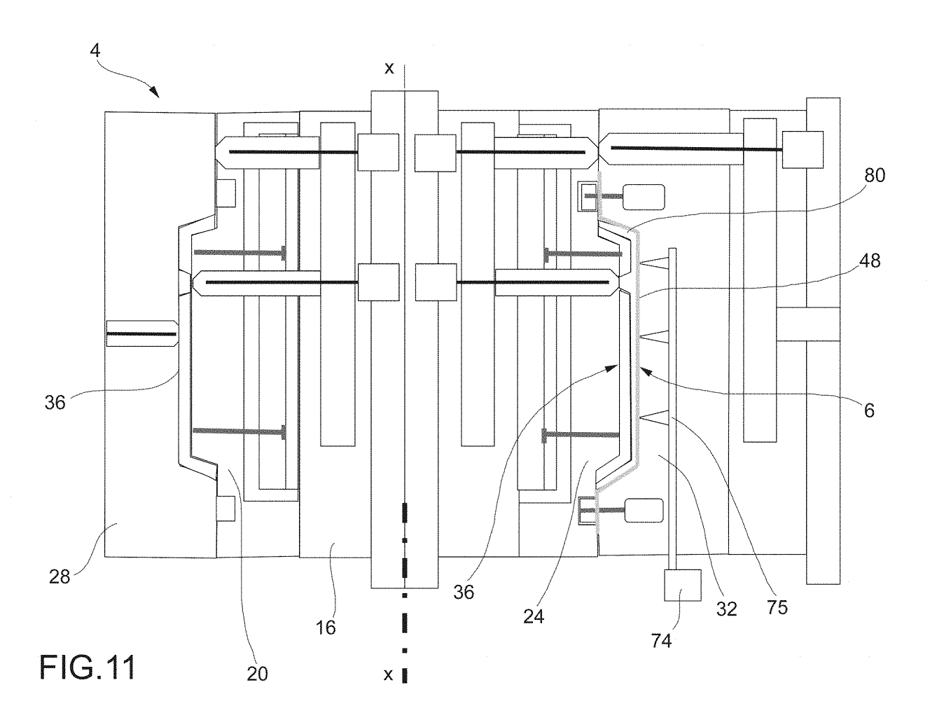

Next, mold 4 is closed, particularly second injection chamber 12 (FIG. 10), and the step for injecting an intermediate layer 80 of plastic material, such as a thermoplastic elastomer (TPE), is performed.

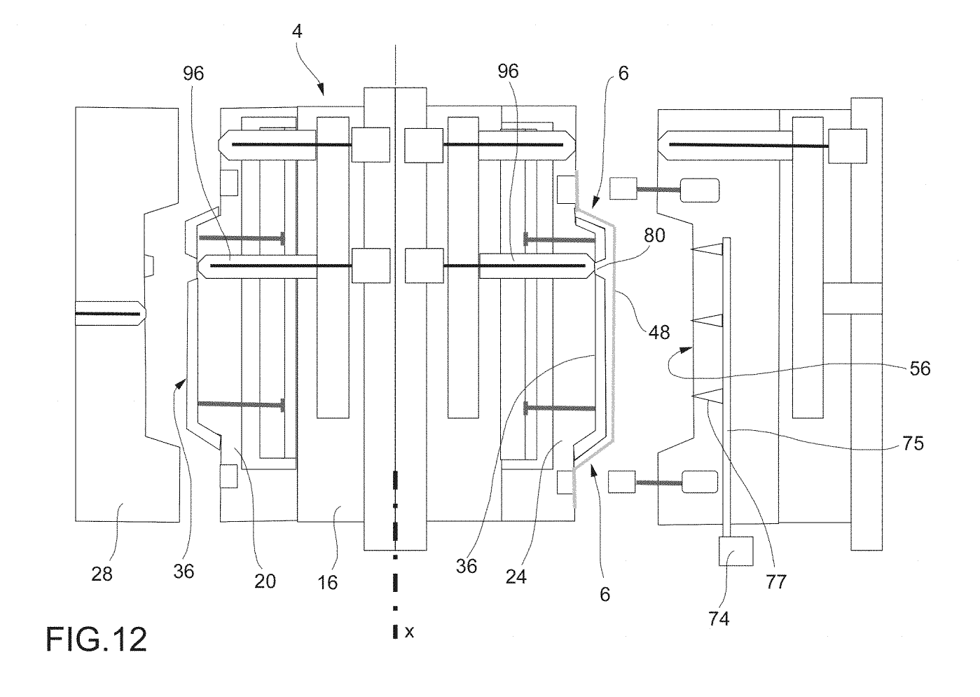

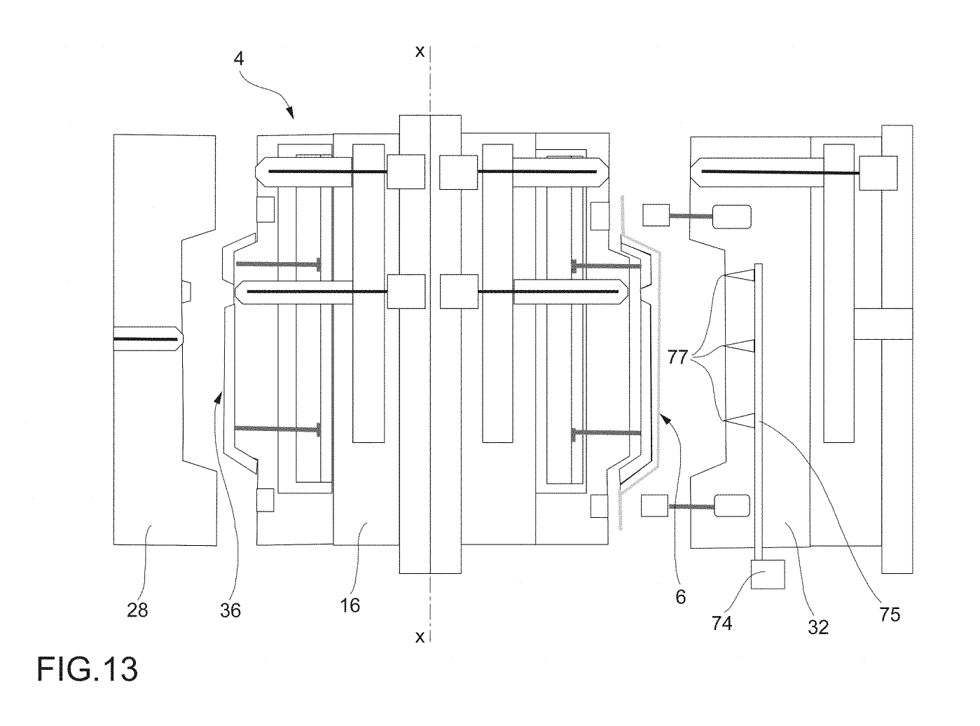

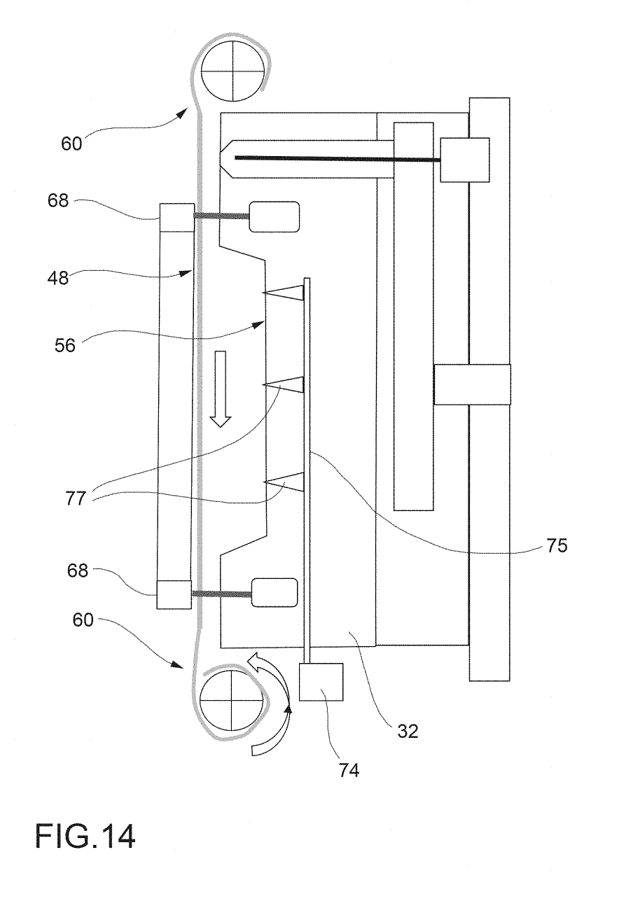

In particular (FIGS. 10-11), intermediate layer 80 is injected into gap 84 located between an inner wall 88 of base 36 facing lining film 48, and an inner surface 92 of lining film 48 opposite said outer surface 52 so as to create a single-piece sandwich structure, wherein said intermediate layer 80 is present between lining film 48 and base 36.

Intermediate layer 80 advantageously has lower hardness than base 36 and in this way forms a yielding padding for lining film 48.

As mentioned earlier, after the first injection into first injection chamber 8, base 36 comprises at least one through hole 40; said through hole 40 is used as an injection hole for intermediate layer 80 of plastic material into second injection chamber 12 on the side of functional wall 44 of the second injection chamber 12.

It should be noted that, according to one possible embodiment, during the step for injecting thermoplastic material into first injection chamber 8, the step for injecting intermediate material into second injection chamber 12 is also carried out through injectors 96 held by said rotating central body 16.

In other words, thanks to the presence of two injection chambers in the same central body 16, it is possible to simultaneously inject both the plastic material of a new base 36 in first injection chamber 12 and intermediate layer 80 on a base 36 previously molded and placed in second injection chamber 12, via through hole 40 (FIG. 11).

This optimizes the molding step.

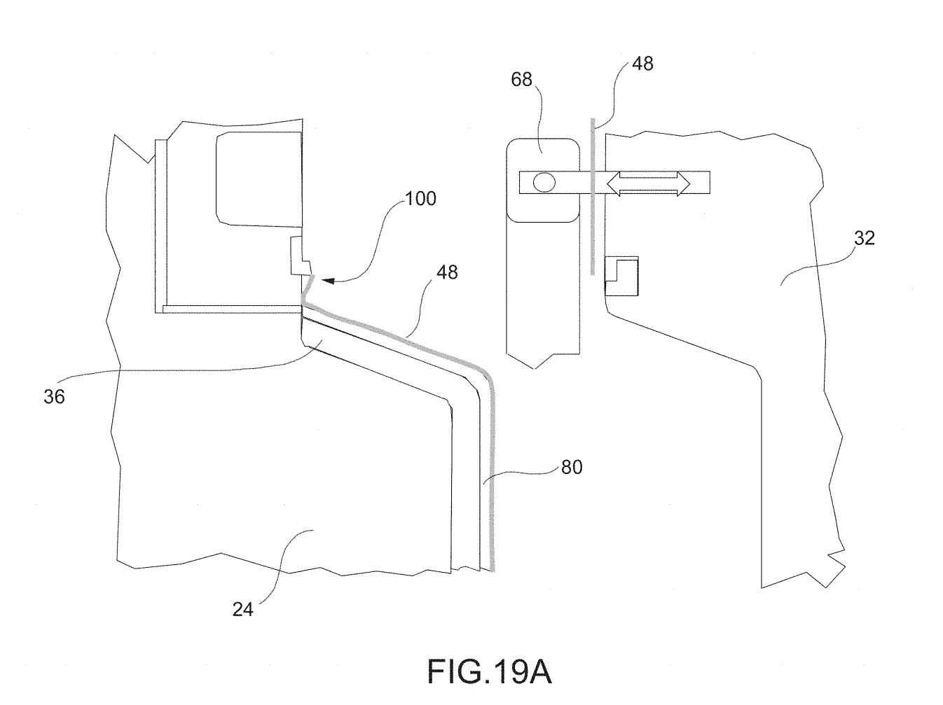

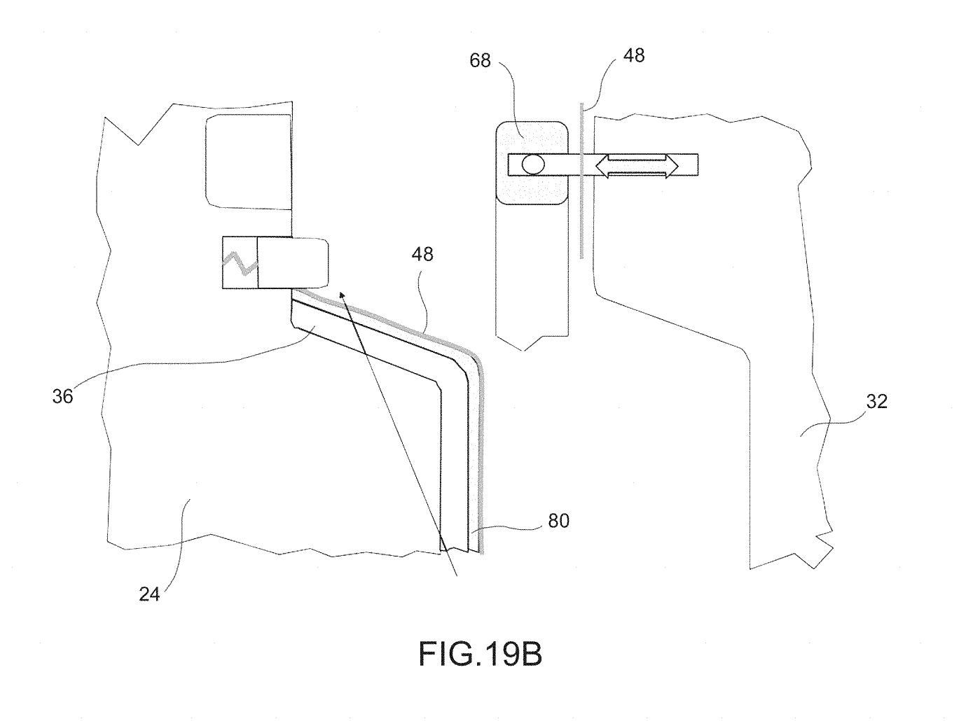

It should be noted that, after injection of intermediate layer 80 of plastic material, there may be a step for cutting the portion of lining film 48 extending beyond second injection chamber 12 by at least one cutter 100 built into mold 4 (FIGS. 18, 19A, 19B).

Cutter 100 is preferably a perimeter cutter that cuts along the perimeter adjacent to the outer contour of molded part 6. Thanks to the fact that it is built into mold 4, molded part 6, already free of the scrap from lining film 48, can be extracted.

The part for vehicles, molded according to the method described above, will include a sandwich structure having:
a base 36 made of thermoplastic material such as polypropylene,
an intermediate layer 80 made of plastic material, such as a thermoplastic elastomer, applied to base 36,
a lining film 48 applied to and covering intermediate layer 80 and base 36,
wherein intermediate layer 80 has lower hardness than base 32 and forms a yielding padding for lining film 48.

As can be seen from the description above, this invention overcomes the drawbacks of the prior art.

In particular, the method of this invention is economical compared to solutions for dashboards lined with real leather, made using the press lamination process.

In addition, this invention is especially resistant to abrasion, scratching, and wear, as well as chemical agents and greases, since the lining film has high mechanical strength and chemical resistance.

In addition, the solution of this invention is pleasing to the touch, since a layer of rubber is placed between the rigid substrate or base made of plastic and the outer lining, making the molded product soft to the touch and therefore similar to a part lined with real leather (but at a significantly higher cost).

Overall, the molding method is reliable, and economical.

The method is also precise, since, thanks to the separate or combined use of a vacuum, compressed air, and/or heating, for example infrared heating, thorough and precise adhesion of the lining film to the mold is achieved without any risk of folds or bubbles.

Adhesion between the lining film and the substrate is assured by the injection of intermediate material serving as a glue between these layers.

The method is also fast and economical thanks to the operation of cutting the excess lining film, preferably inside the actual mold, so that a finished part can be extracted from the second injection chamber.

The lining film also provides the necessary resistance to abrasion and wear thanks to the intermediate layer which, by deforming upon contact with foreign bodies, is capable of absorbing impacts.

In addition, the lining film allows for considerable customization of the graphic effect intended for the part, and furthermore provides noteworthy resistance to the corrosive action of greases and similar substances, which consequently cannot damage the plastic material beneath the film.

In this way, the film serves as both a customizable esthetic element and a protective element.

In an effort to meet specific and contingent requirements, an engineer in the field may apply numerous modifications and variants to the molding methods described above, all of which are included in the scope of the invention as defined by the following claims.

1. An injection molding method of a part for vehicle interiors, comprising the steps of:
arranging a mold having a first injection chamber shaped to define in negative a base of said part;
injecting thermoplastic material into said first injection chamber;
extracting the base from the first injection chamber and placing the base in a second injection chamber on the side of a functional wall of said second injection chamber;
inserting a lining film in said second injection chamber and deforming the lining film so as to arrange the lining film, on a side of an outer surface thereof, adhering to an esthetic wall of the second injection chamber opposite the functional wall;
injecting an intermediate layer of plastic material, in a gap between an inner wall of the base facing the lining film, and an inner surface of the lining film opposite said outer surface so as to create a single sandwich structure, wherein said intermediate layer is present between the lining film and the base;
the intermediate layer having lower hardness than the base and forming a yielding padding for the lining film.

2. An injection molding method according to claim 1, wherein following the first injection in the first injection chamber, the base defines at least one through hole, said through hole being used as an injection hole for the intermediate layer of plastic material into the second injection chamber, on the side of the functional wall of the second injection chamber.

3. An injection molding method according to claim 1, wherein a step is provided to feed the lining film into the second injection chamber through an automatic feeding device and, through a locking and sealing device, peripherally sealing against the mold, on the side of the esthetic wall, a portion of said lining film equal to or greater than the base to exceed the second injection chamber, to create a sealed chamber between the lining film and the esthetic wall of the second injection chamber.

4. An injection molding method according to claim 3, wherein a step is provided to create a vacuum inside the sealed chamber to promote deformation and adhesion of the lining film to the esthetic wall of the second injection chamber.

5. An injection molding method according to claim 3, wherein a step is provided to blow compressed air into a second sealed chamber to promote deformation and adhesion of the lining film to the esthetic wall of the second injection chamber.

6. An injection molding method according to claim 3, wherein a step is provided to associate the locking and sealing device with a heating device to heat the lining film during a step of deformation and adhesion of the lining film to the esthetic wall of the second injection chamber.

7. An injection molding method according to claim 1, wherein following injection of the intermediate layer of plastic material, a step is provided to cut a portion of lining film extending beyond the second injection chamber by at least one cutter built into the mold.

8. An injection molding method according to claim 1, wherein a step is provided to provide a cube-shaped mold having a central body rotating about an axis of rotation, said central body supporting a pair of punches diametrically opposed to each other, alternately facing the first injection chamber and the second injection chamber.

9. An injection molding method according to claim 8, wherein, during the step of thermoplastic material injection in the first injection chamber, the step for injecting the intermediate layer in the second injection chamber is also carried out through injectors supported by said rotating central body.

10. A molded part for vehicle interiors obtained through a molding method according to claim 1.

11. A molded part for vehicle interiors comprising a sandwich structure comprising:
a base made of thermoplastic material;
an intermediate layer made of plastic material, such as a thermoplastic elastomer, applied to the base;
a lining film applied to cover the intermediate layer and the base;
wherein the intermediate layer has lower hardness than the base and forms a yielding padding for the lining film.

12. A molded part for vehicle interiors according to claim 11, wherein the base is made of polypropylene.
